(19) United States
(12) Patent Application Publication
(10) Pub. No.: US 2023/0324567 A1
(43) Pub. Date: Oct. 12, 2023

(54) Method for Estimating at least One System State by Means of a Kalman Filter

(71) Applicant: Robert Bosch GmbH, Stuttgart (DE)

(72) Inventor: Simon Weissenmayer, Flein (DE)

(21) Appl. No.: 18/182,056

(22) Filed: Mar. 10, 2023

(30) Foreign Application Priority Data
Mar. 24, 2022 (DE) 10 2022 202 931.3

(51) Int. Cl. G01S 19/45; G06F 17/18

(52) U.S. Cl. CPC G01S 19/45; G06F 17/18

(57) ABSTRACT

In a method for estimating at least one system state using a Kalman filter, measured values measured by at least one sensor are fed to the Kalman filter and the Kalman filter outputs an estimation result and at least one associated item of information concerning the reliability of the estimation result by carrying out a prediction step and a correction step. The method includes determining a description of a state in a time step taking into account a description of a state from a previous time step, determining a filtered description of the state at the same time step taking into account the description of the determined state and a filtered description of a state from a previous time step, and determining information concerning the reliability of the prediction at the time step taking into account the description of the determined state and the filtered description of the determined state.

This application claims priority under 35 U.S.C. §119 to application no. DE 10 2022 202 931.3, filed on Mar. 24, 2022 in Germany, the disclosure of which is incorporated herein by reference in its entirety.

The disclosure relates to a method for estimating at least one system state by means of a Kalman filter, a computer program for carrying out the method, a machine-readable storage medium on which the computer program is stored and a system for determining the position of a mobile object, such as in particular a vehicle, configured to carry out the method. The disclosed method can in particular be used in the context of at least partially automated or autonomous driving.

### BACKGROUND

Kalman filters are used to iteratively estimate system states on the basis of observations which are typically prone to error. In this context, Kalman filters have proven to be particularly advantageous in particular for applications in which sensor information from different sensors has to be combined (or fused) in particular with model information. Moreover, since their calculations are advantageously accurate and robust, Kalman filters are often used in embedded systems. In addition, microcontrollers can advantageously carry out the calculations of a Kalman filter in an advantageously efficient manner.

The Kalman filter equations can be described in matrix notation as follows:

$${\hat{x}}_{k} = {F}_{k} {\hat{x}}_{k - 1} + {B}_{k} \vec{{u}_{k}} \qquad \text{(1)}$$

$${P}_{k} = {F}_{k} {P}_{k - 1} {F}_{k}^{T} + {Q}_{k} \qquad \text{(2)}$$

$${K}^{′} = {P}_{k} {H}_{K}^{T} {\left({H}_{k} {P}_{k} {H}_{k}^{T} + {R}_{k}\right)}^{- 1} \qquad \text{(3)}$$

$${{\hat{x}}^{′}}_{k} = {\hat{x}}_{k} + {K}^{′} \left(\vec{{z}_{k}} - {H}_{k} {\hat{x}}_{k}\right)$$

$${{P}^{′}}_{k} = {P}_{k} - {K}^{′} {H}_{k} {P}_{k} \qquad \text{(5)}$$

Equations GL1 and GL2 describe the iterative estimation process of the Kalman filter and equations GL3 to GL5 describe the correction and fusion of the iteratively estimated model values with measured values acquired by means of sensors. For a more detailed explanation, reference is made the description of a typical structure of a Kalman filter in connection with FIG. 1.

Kalman filters are comparatively complex, however, and there are numerous setting options (in particular the system matrix Fₖ, the variance matrix Rₖ of the measurement noise and the variance matrix Qₖ of the system noise) that have to be selected and/or set for the respective system behavior to be described. This makes it difficult to use the Kalman filter for new applications and/or to maintain existing applications.

For nonlinear models, the extended Kalman filter is known as well:

$${\hat{x}}_{k} = f \left({\hat{x}}_{k - 1} , \vec{{u}_{k}}\right) \qquad \text{(6)}$$

$${P}_{k} = {F}_{k} {P}_{k - 1} {F}_{k}^{T} + {G}_{k} {Q}_{k} {G}_{k}^{T} \qquad \text{(7)}$$

$${K}^{′} = {P}_{k} {H}_{k}^{T} {\left({H}_{k} {P}_{k} {H}_{k}^{T} + {R}_{k}\right)}^{- 1} \qquad \text{(8)}$$

$${{\hat{x}}^{′}}_{k} = {\hat{x}}_{k} + {K}^{′} \left(\vec{{z}_{k}} - {h}_{k} \left({\hat{x}}_{k}\right)\right) \qquad \text{(9)}$$

$${{P}^{′}}_{k} = {P}_{k} - {K}^{′} {H}_{k} {P}_{k} \qquad \text{(10)}$$

Also known are so-called sigma-point Kalman filters. The group of sigma-point Kalman filters is an alternative to the use of an extended Kalman filter. The basic idea of the sigma-point Kalman filters is to represent the mean and covariance of a normally distributed random vector using a set of deterministically chosen sigma points, wherein each sigma point can be understood as a state vector. The propagation of the random vector by a nonlinear function is realized by propagating the individual sigma points using this nonlinear function and then calculating the mean and variance of these transformed sigma points.

$${\hat{P}}_{k} = {\sum }_{i = 0}^{2 n} {W}_{i , x} \left({\hat{X}}_{i , k} - {\hat{x}}_{\text{E} , k - 1}\right) {\left({\hat{X}}_{i , k} - {\hat{x}}_{\text{E} , k - 1}\right)}^{T} \qquad \text{(11)}$$

$${\hat{P}}_{z z , k} = {W}_{i , z} \left(h \left({\hat{X}}_{i , k}\right) - {z}_{\text{E} , k - 1}\right) {\left(h \left({\hat{X}}_{i , k}\right) - {z}_{\text{E} , k - 1}\right)}^{T} + {R}_{k} \qquad \text{(12)}$$

and

$${\hat{P}}_{x z , k} = {W}_{i , z} \left({\hat{X}}_{i , k} - {\hat{x}}_{\text{E} , k - 1}\right) {\left(h \left({\hat{X}}_{i , k}\right) - {z}_{\text{E} , k - 1}\right)}^{T} \qquad \text{(13)}$$

with the sigma points

$${\hat{X}}_{i , k} = \left[{\hat{x}}_{k} {\hat{x}}_{k} + \sqrt{n + {λ}_{U K F}} {C}^{T} {\hat{x}}_{k} - \sqrt{n + {λ}_{U K F}} {C}^{T}\right] \qquad \text{(14)}$$

with the expected values

$${\hat{x}}_{\text{E} , k - 1} = {\sum }_{i = 0}^{2 n} {W}_{i , x} {\hat{X}}_{i , k} \qquad \text{(15)}$$

and

$${\text{z}}_{\text{E} , k - 1} = {\sum }_{i = 0}^{2 n} {W}_{i , z} h \left({\hat{X}}_{i , k}\right) \qquad \text{(16)}$$

When implementing sigma-point Kalman filters on control devices or in sensors, the computational effort can be very high. For this reason, the Kalman filter calculations often cannot be carried out as often as new measurement data is available. To avoid aliasing effects, the measured values are usually first filtered with a low-pass filter and only every nth measurement step is provided with a calculation step of prediction or correction.

In addition to a particularly favorable consideration of nonlinearities, sigma-point Kalman filters exhibit an advantageously good robustness with respect to modeling errors.

One object of the disclosure is improving a Kalman filter in such a way that the advantageous properties described in connection with the sigma-point Kalman filter are preserved as much as possible, while at the same time being able to advantageously reduce the computational effort or advantageously increase the performance with the same computational effort.

### SUMMARY

Proposed here is a method for estimating at least one system state by means of a Kalman filter, wherein measured values measured by at least one sensor of the system are fed to the Kalman filter and wherein the Kalman filter outputs an estimation result and at least one associated item of information concerning the reliability of the estimation result by carrying out a prediction step and a correction step, comprising at least the following steps:
a) determining a description of a state in a time step taking into account a description of a state from a previous time step,
b) determining a filtered description of the state at the same time step taking into account the description of the state determined in step a) and a filtered description of a state from a previous time step,
c) determining information concerning the reliability of the prediction step at the time step taking into account the description of the state determined in step a) and the filtered description of the state determined in step b).

The specified sequence of steps a), b) and c) is an example and can be carried out in the thus specified sequence, for example in a normal operating process, at least once to implement the method. Alternatively or additionally, steps a), b) and c), in particular steps a) and b), can be carried out at least partially in parallel or simultaneously. The method can be carried out by a control device, such as a (micro)controller, for instance, which can be a part of the system also described here, for example.

The method advantageously enables the advantageous properties described in connection with the sigma-point Kalman filter to be preserved as much as possible, while at the same time advantageously reducing the computational effort or advantageously increasing the performance with the same computational effort. This is achieved in particular by filtering the states or model values instead of the measured values or alternatively to the measured values or possibly in addition to the measured values.

The Kalman filter can be a sigma-point Kalman filter, for example, or the Kalman filter can advantageously operate in the manner of a sigma-point Kalman filter. The method can advantageously be carried out without a Cholesky decomposition for obtaining sigma points. At least partially noisy measured values and/or at least partially noisy model values, for example, can be used here (instead) as sigma points. In particular, in this context, a mean value calculation of a “sigma point ensemble” or measured value ensemble can advantageously by replaced by a PT1 filter. It can furthermore advantageously be implemented that historical “sigma points” or measured values are not stored. For example, each measured value can correct the mean value only once per time step.

The method can advantageously also be used in embedded Kalman filter applications. In particular in applications in which nonlinear models are calculated.

The method contributes in particular to the (continuous) determination of system states using the Kalman filter and as a function of sensor data. The Kalman filter can be provided with measured values from a plurality of different sensors or different types of sensors of the system in order to carry out an estimation taking these measured values into account. The at least one system state can include the (current) (ego) position of a mobile object or mobile unit, for example, in particular one that can be moved along the earth’s surface, such as a (motor) vehicle (car), a ship, an aircraft, a smartphone or a smartwatch. The at least one system state can also include a (current) speed, a (current) direction of movement, and/or a (current) acceleration of the object. The use of the described method is generally advantageous for any sensor data fusion tasks, such as position determination, object detection and/or vehicle dynamics control for a vehicle. The described method can moreover also be used of modeling transmission characteristics of a sensor, for example to reduce measurement noise and other disruptive influences on the sensor signal.

In step a), a description of a state (formula symbol: x̂ₖ) in a time step (formula symbol: k) is determined taking into account a description of a state (formula symbol: x̂ₖ₋₁) from a previous time step (formula symbol: k-1). This can be done according to the above equations (1) and/or (6), for example.

In step b), a filtered description of the state (formula symbol: x̂_{filt,k}) at the same time step (formula symbol: k) is determined taking into account the description of the state (formula symbol: x̂ₖ) determined in step a) and a filtered description of a state (formula symbol: x̂_{filt,k-1}) from a previous time step (formula symbol: k-1). This can supplement the calculations according to equations (1) and/or (6).

In particular the expected value calculations of x̂_{E,k-1} or z_{E,k-1} from equations(15) and (16), can advantageously be approximated using filters with an infinite impulse response (e.g., PT1 filter). The calculation of sigma particles can particularly advantageously be replaced by the here-described filtering in order to achieve the benefit of an advantageously significantly higher measurement and/or processing frequency. For example, instead of equation (2) or (15), a state x̂ₖ filtered in particular with a low-pass filter can be calculated from the state x̂_{filt,k}.

For example, in step b), the filtered description of the state can be calculated as follows:

$${\hat{x}}_{\text{filt} , k} = \left(1 - \frac{Δ t}{{T}_{x}}\right) {\hat{x}}_{\text{filt} , k - 1} + \frac{Δ t}{{T}_{x}} {\hat{x}}_{k} , \qquad \text{(17)}$$

wherein Δt describes the duration of the time step and Tₓ describes the time constant of a filter, such as a PT1 filter for correcting the state.

In step c), information concerning the reliability (formula symbol: Pₖ) of the prediction step at the time step (formula symbol: k) is determined taking into account the description of the state (formula symbol: x̂ₖ) determined in step a) and the filtered description of the state determined in step b) (formula symbol: x̂_{filt,k}).

In this context, a covariance P̂ₖ of the deviations between the filtered state x̂_{filt,k} and the state can be x̂ₖ calculated, for example. This can be done as follows, for example:

$${\hat{P}}_{k} = \left({\hat{x}}_{k} - {\hat{x}}_{\text{filt} , k - 1}\right) {\left({\hat{x}}_{k} - {\hat{x}}_{\text{filt} , k - 1}\right)}^{T} \qquad \text{(18)}$$

Furthermore, for example, in step c), the covariance matrix (formula symbol: Pₖ) can be corrected with the covariance of the deviation to describe the reliability of the prediction step and, for this purpose, can calculated as follows, for example:

$${P}_{k} = \left(1 - \frac{Δ t}{{T}_{P}}\right) {P}_{k - 1} + \frac{Δ t}{{T}_{P}} {\hat{P}}_{k} , \qquad \text{(19)}$$

wherein Δt describes the duration of the time step and Tₓ describes the time constant of a filter, such as a PT1 filter for correcting the state, and T_{P} describes the time constant of a filter, such as a PT1 filter for correcting the covariance matrix.

This form of the calculation of the covariance matrix Pₖ is especially advantageous for extended Kalman filters, in which the model equations are in particular nonlinear and/or the predicted state x̂ₖ is calculated as with equations (6) to (10).

According to an advantageous embodiment, it is proposed that the system is a system for determining the position of a vehicle. Corresponding systems typically operate with numerous sensor measured values, so that the method can be particularly advantageous here.

The system can be a system for determining the position of an object, such as a (motor) vehicle, in particular a car, for instance. The system can be disposed at least partially in or on the object, such as the vehicle. The vehicle can advantageously be set up for at least partially automated and/or autonomous driving operation, for example by means of an appropriately configured control unit. The control unit can be connected to the system in order to receive position data from the system. The system can comprise a plurality of sensors, in particular different sensors or different types of sensors, or can be connected to sensors of the vehicle. The sensors can, for instance, include at least one GNSS sensor and an (optical or acoustic) surroundings sensor, such as a camera sensor, LIDAR sensor, RADAR sensor, ultrasonic sensor or the like. The measured values from the sensors can be fused by means of the here-described method or by means of the Kalman filter.

For example, at least one measured value can be used unfiltered in step a) to determine the description of the state (formula symbol: x̂ₖ).

According to a further advantageous embodiment, it is proposed that, in step b), a low-pass filter or PT1 filter is used to determine the filtered description of the state (formula symbol: x̂_{filt,k}).

According to a further advantageous embodiment, it is proposed that, in step c), a low-pass filter or PT1 filter is used to determine the information concerning the reliability of the prediction step (formula symbol: Pₖ).

According to a further advantageous embodiment, it is proposed that, in step c), a description of a weighting is taken into account to determine the information concerning the reliability of the prediction step (formula symbol: Pₖ).

For example, in this context, equation (18) can be extended as follows, in particular so that static measurement errors and model errors can advantageously be taken into account as well in addition to the measurement noise:

$${\hat{P}}_{k} = \left({\vec{w}}_{x} ∘ \left({\hat{x}}_{k} - {\hat{x}}_{\text{filt} , k - 1}\right)\right) {\left({\vec{w}}_{x} ∘ \left({\hat{x}}_{k} - {\hat{x}}_{\text{filt} , k - 1}\right)\right)}^{T} \qquad \text{(20)}$$

The weight vector wₓ can be multiplied element by element with the difference between the filtered state x̂_{filt,k} and the state x̂ₖ.

The weighting preferably takes into account at least one item of information about the system noise (formula symbol: σₓ) and/or at least one model error (formula symbol: eₓ).

The weights wₓ of the vector w̅ₓ, for example, can be calculated from the standard deviation σₓ of the system noise and the model error eₓ as follows:

$${w}_{x} = \frac{{σ}_{x} + {e}_{x}}{{σ}_{x}} \qquad \text{(21)}$$

When designing the filter, the weights can initially be selected to be 1, and if the error of a model value in the covariance matrix is too small the value of the weight can then advantageously be increased.

According to a further advantageous embodiment, it is proposed that the Kalman gain (K′) is determined using a low-pass filtered measurement vector (ẑ_{filt,k}).

For example, in particular analogous to the calculation of the covariance matrix Pₖ according to the equations (17) to (21), the Kalman gain K′ can also be calculated alternatively to the equations (3) and (8) or (16) as follows:

First, using the measurement model, hₖ (x̂ₖ) a low-pass filtered measurement vector can be calculated as follows:

$${\hat{\text{z}}}_{\text{filt} , k} = \left(1 - \frac{Δ t}{{T}_{z}}\right) {\hat{\text{z}}}_{\text{filt} , k - 1} + \frac{Δ t}{{T}_{z}} {h}_{k} \left({\hat{x}}_{k}\right) \qquad \text{(22)}$$

From this, the covariance P_{zz,k} of the measurement noise can be calculated as follows:

$${\hat{P}}_{z z , k} = \left({\vec{w}}_{z} ∘ \left(h \left({\hat{x}}_{k}\right) - {z}_{\text{filt} , k - 1}\right)\right) {\left({\vec{w}}_{z} ∘ \left(h \left({\hat{x}}_{k}\right) - {z}_{\text{filt} , k - 1}\right)\right)}^{T} + {R}_{k} \qquad \text{(23)}$$

The weighting can be determined as follows:

$${w}_{z} = \frac{{σ}_{z} + {e}_{z}}{{σ}_{z}} \qquad \text{(24)}$$

This can further be used to calculate the low-pass filtered covariance as follows:

$${P}_{z z , k} = \left(1 - \frac{Δ t}{{T}_{z z}}\right) {P}_{z z , k - 1} + \frac{Δ t}{{T}_{z z}} {\hat{P}}_{z z , k} \qquad \text{(25)}$$

The cross-correlation P_{xz,k} between the model values and the measured values in this context can moreover be determined as follows:

$${\hat{P}}_{x z , k} = \left({\vec{w}}_{x} ∘ \left({\hat{x}}_{k} - {\hat{x}}_{\text{filt} , k - 1}\right)\right) {\left({\vec{w}}_{z} ∘ \left(h \left({\hat{x}}_{k}\right) - {z}_{\text{filt} , k - 1}\right)\right)}^{T} \qquad \text{(26)}$$

The filtered value P_{xz,k} thereof can advantageously be determined as follows:

$${P}_{x z , k} = \left(1 - \frac{Δ t}{{T}_{x z}}\right) {P}_{x z , k - 1} + \frac{Δ t}{{T}_{x z}} {\hat{P}}_{x z , k} \qquad \text{(27)}$$

With the help of these quantities, the Kalman gain K′ can advantageously be determined as follows:

$${K}^{′} = {P}_{x z , k} {P}_{z z , k}^{- 1} \qquad \text{(28)}$$

Using the Kalman gain, the a-posteriori state estimate

$${{\hat{x}}^{′}}_{k}$$

can be determined as follows:

$${{\hat{x}}^{′}}_{k} = {\hat{x}}_{k} + {K}^{′} \left(\vec{{z}_{k}} - h \left({\hat{x}}_{k}\right)\right) \qquad \text{(29)}$$

The covariance matrix

$${{P}^{′}}_{k}$$

Pₖ can then be determined as follows:

$${{P}^{′}}_{k} = {P}_{k} - {K}^{′} {P}_{x z , k}^{T} \qquad \text{(30)}$$

According to a further aspect, a computer program for carrying out a method presented here is proposed. This relates in other words in particular to a computer program (product) comprising instructions that, when the program is executed by a computer, prompt said computer to carry out a here-described method.

According to a further aspect, a machine-readable storage medium on which the here-proposed computer program is stored or saved is proposed. The machine-readable storage medium is typically a computer-readable data carrier.

According to a further aspect, a system for determining the position of a mobile object, such as a vehicle, configured to carry out a here-described method is proposed as well.

The system for determining the position of a mobile object can, for example, be provided and configured to determine the ego position of a mobile object and/or to measure the position relative to other, in particular moving, mobile objects, such as road users. The system can comprise a movement and position sensor configured to carry out a here-described method, for example. The movement and position sensor can moreover receive GNSS data and/or surroundings sensor data (from surroundings sensors of the mobile object or vehicle), for example. To carry out the method, the system can include a computing device, such as a (micro)controller, for instance, which can access the here-described computer program. In this context, the storage medium can, for example, likewise be a part of or connected to the system.

The details, features and advantageous configurations discussed in connection with the method can accordingly also occur in the computer program presented here and/or the storage medium and/or the system and vice versa. In this respect, reference is made to the entirety of the statements there for a more specific characterization of the features.

### BRIEF DESCRIPTION OF THE DRAWINGS

The solution presented here and its technical environment are explained in more detail in the following with reference to the figures. It should be noted that the disclosure is not intended to be limited by the embodiment examples shown. In particular, unless explicitly stated otherwise, it is also possible to extract partial aspects of the facts explained in the figures and to combine them with other components and/or insights from other figures and/or the present description. The figures show schematically:

FIG. 1: a typical signal flow diagram of a Kalman filter according to the prior art,

FIG. 2: an example of a sequence of the method presented here, and

FIG. 3: an example of system for determining the position of a vehicle.

### DETAILED DESCRIPTION

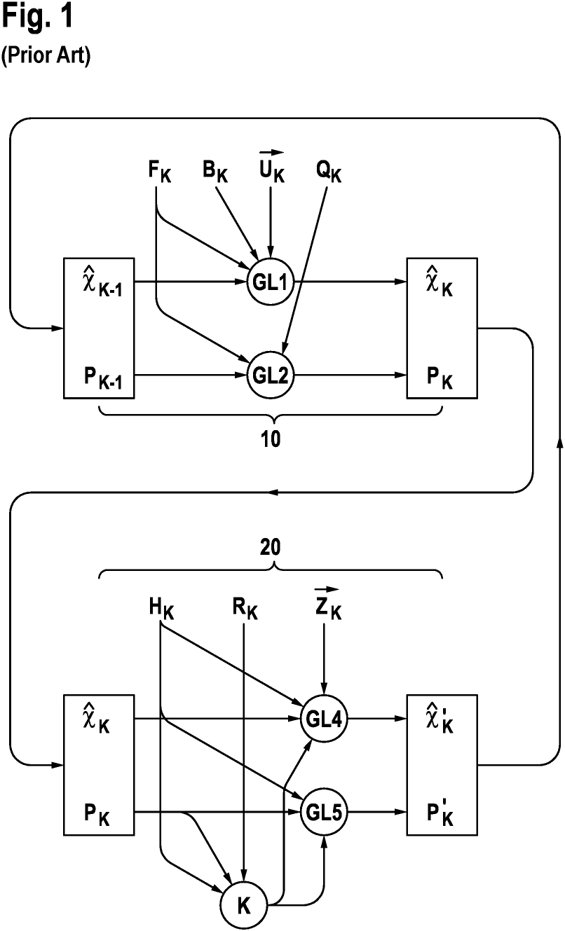

FIG. 1 schematically shows a typical structure of a Kalman filter according to the prior art. The Kalman filter equations on which this structure is based can be described in matrix notation as follows:

$${\hat{x}}_{k} = {F}_{k} {\hat{x}}_{k - 1} + {B}_{k} \vec{{u}_{k}} \qquad \text{(GL31)}$$

$${P}_{k} = {F}_{k} {P}_{k - 1} {F}_{k}^{T} + {Q}_{k} \qquad \text{(GL32)}$$

$${\underbrace{{H}_{k} {K}^{′}}}_{K} = {\underbrace{{H}_{k} {P}_{k} {H}_{k}^{T}}}_{{\text{Σ}}_{0}} {\left({\underbrace{{H}_{k} {P}_{k} {H}_{k}^{T}}}_{{\text{Σ}}_{0}} + {\underbrace{{R}_{k}}}_{{\text{Σ}}_{1}}\right)}^{- 1} \qquad \text{(GL33)}$$

$${\underbrace{{H}_{k} {\hat{{x}^{′}}}_{k}}}_{{μ}^{′}} = {\underbrace{{H}_{k} {\hat{x}}_{k}}}_{{μ}_{0}} + {\underbrace{{H}_{k} {K}^{′}}}_{K} \left({\underbrace{\overline{{z}_{k}}}}_{{μ}_{1}} - {\underbrace{{H}_{k} {\hat{x}}_{k}}}_{{μ}_{0}}\right) \qquad \text{(GL34)}$$

$${\underbrace{{H}_{k} {{P}^{′}}_{k} {H}_{k}^{T}}}_{{\text{Σ}}^{′}} = {\underbrace{{H}_{k} {P}_{k} {H}_{k}^{T}}}_{{\text{Σ}}_{0}} - {\underbrace{{H}_{k} {K}^{′}}}_{K} {\underbrace{{H}_{k} {P}_{k} {H}_{k}^{T}}}_{{\text{Σ}}_{0}} \qquad \text{(GL35)}$$

Equation (GL1) describes the estimated state vector x̂ₖ based on the state vector of x̂ₖ₋₁ the previous time step (iterative estimation), the system matrix Fₖ, the control matrix Bₖ and the control vectoru̅ₖ̅. The state vectors usually describe mean values of Gaussian distributions. In other words, according to equation (GL1), the new best estimate x̂ₖ is a prediction made from the previous best estimate x̂ₖ₋₁ plus a correction for known external influences.

In this context, equation (GL2) describes the covariance matrix x̂ₖ associated with the Gaussian distribution of the estimated state vector Pₖ. This is obtained based on the covariance matrix Pₖ₋₁ of the previous time step (iterative estimation), the system matrix Fₖ and the covariance matrix of the system noise Qₖ. In other words, according to equation (GL2), the new (estimation) uncertainty Pₖ is predicted from the old uncertaintyPₖ₋₁, with an additional uncertainty from the environment.

Equation (GL3) describes the so-called Kalman gain K or the Kalman gain matrix K′. This is formed on the basis of the covariance matrix Pₖ, the observation matrix Hₖ and the covariance matrix of the measurement noise Rₖ. Together with the observation matrix Pₖ, the covariance matrix Hₖ can form the covariance matrix Σ₀ of the model value vector µ₀.

Equation (GL4) describes the correction of the estimated state vector x̂ₖ or the model value vector µ₀ with measured values represented by the measured value vector zₖ or µ₁. Equation (GL4) thus produces a corrected or fused model value vector µ′ or a new state

$$\text{vector} {\hat{{x}^{′}}}_{k} ,$$

which can serve as the input for a subsequent estimation step.

Equation (GL5) describes the determination of the corrected or fused covariance matrix

$${{P}^{′}}_{k}$$

Pₖ or Σ′ based on the covariance matrix Pₖ or Σ₀ of the state vector x̂ₖ or the model value vector µ₀. The covariance matrix Rₖ or Σ₁ of the measured value vector zₖ or µ₁ is included via the Kalman gain K.

The equations (GL1) and (GL2) thus describe the iterative estimation process of the Kalman filter. This estimation process is identified in FIG. 1 with the reference sign 10 and is also referred to here as the prediction step. The equations (GL3) to (GL5) describe the subsequent correction or fusion of the iteratively estimated model values with measured values acquired by means of sensors. This correction or fusion is identified in FIG. 1 with the reference sign 20, and is also referred to here as the correction step. The corrected or fused (new) model values can be used in a subsequent iteration step in the estimation process 10. This is illustrated with the return arrow in FIG. 1.

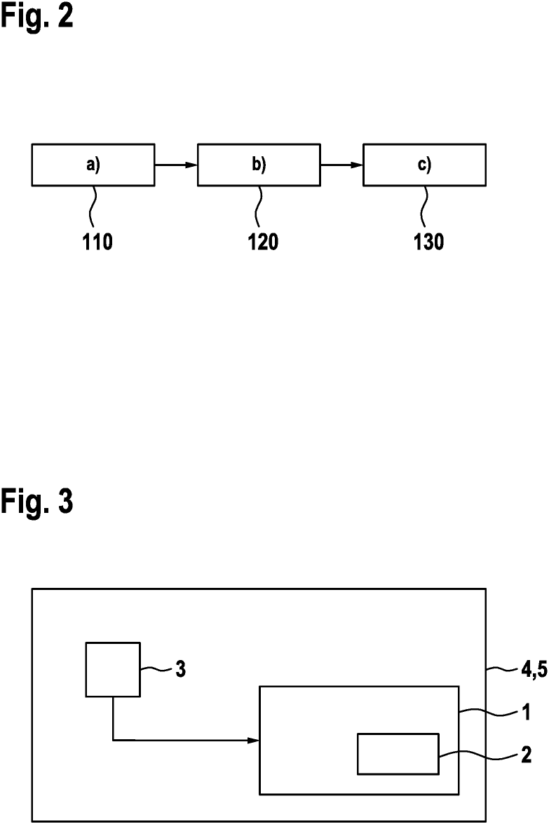

FIG. 2 schematically shows an example of a sequence of the method presented here. The method is used to estimate at least one system state (x̂) by means of a Kalman filter 2, wherein measured values measured by at least one sensor 3 of the system 1 are fed to the Kalman filter 2 and wherein the Kalman filter 2 outputs an estimation result

$$\left({{\hat{x}}^{′}}_{k}\right)$$

and at least one associated item of information

$$\left({{P}^{′}}_{k}\right)$$

concerning the reliability of the estimation result by carrying out a prediction step and a correction step.

The sequence of steps a), b) and c) shown with blocks 110, 120 and 130 is an example and can, for example, be carried out at least once in the shown sequence to carry out the method. The steps a), b) and c), in particular steps a) and b), can furthermore also be carried out at least partially in parallel or simultaneously.

In block 110, according to step a), a description (x̂ₖ) of a state in a time step is determined taking into account a description (x̂ₖ₋₁) of a state from a previous time step.

In block 120, according to step b), a filtered description (x̂_{filt,k}) of the state at the same time step is determined taking into account the description (x̂ₖ) of the state determined in step a) and a filtered description of a state from a previous time step.

For example, in block 120, a low-pass filter or PT1 filter can be used to determine the filtered description (x̂_{filt,k}) of the state.

In block 130, according to step c), information (Pₖ) concerning the reliability of the prediction step at the time step is determined taking into account the description (x̂ₖ) of the state determined in step a) and the filtered description (x̂_{filt,k}) of the state determined in step b).

For example, in block 130, a low-pass filter or PT1 filter can be used to determine the information (Pₖ) concerning the reliability of the prediction step.

In block 130, a description (w̅ₓ) of a weighting can be taken into account as well, for example, to determine the information (Pₖ) concerning the reliability of the prediction step. The weighting can take into account at least one item of information about the system noise (σₓ) and/or at least one model error (eₓ), for example.

Furthermore, for example, the Kalman gain (K′) can advantageously be determined here using a low-pass filtered measurement vector (ẑ_{filt,k}).

FIG. 3 schematically shows an example of system 1 for determining the position of a mobile object 5 configured to carry out a here-described method. The object 5 is a vehicle 4, for example. Here, for example, said vehicle comprises a sensor 3 which provides data to a Kalman filter 2 of the system 1.

The system 1 can advantageously be a system 1 for determining the position of the vehicle 4.

The here-described method and the here-described system in particular enable one or more of the following advantages:
The typically very computing time intensive Cholesky decomposition for obtaining sigma points can advantageously be omitted. The noisy measured values and model values, for example, can be used (instead) as sigma points.
The mean value calculation of a “sigma point ensemble” or measured value ensemble can advantageously by replaced by a PT1 filter. Especially advantageously, this is very resource-conserving, because there is in particular no need to store past “sigma points” or measured values and each measured value corrects the mean value only once per time step, for example.
The method can particularly advantageous be used in embedded Kalman filter applications in which nonlinear models are calculated and which benefit from higher performance with the same consumption of resources.

1. A method for estimating at least one system state with a Kalman filter in which measured values measured by at least one sensor of the system are fed to the Kalman filter and the Kalman filter outputs an estimation result and at least one associated item of information concerning a reliability of the estimation result by carrying out a prediction and a correction, the method comprising:
determining a first description of a first state in a time step taking into account a second description of a second state from a previous time step;
determining a filtered description of the first state at the time step taking into account the first description of the first state and a filtered description of the second state from the previous time step; and
determining information concerning a reliability of the prediction at the time step taking into account the first description of the first state and the filtered description of the first state.

2. The method according to claim 1, wherein the system is a system for determining the position of a vehicle.

3. The method according to claim 1, wherein the determining of the filtered description includes using a low-pass filter or PT1 filter to determine the filtered description.

4. The method according to claim 1, wherein the determining of the information includes using a low-pass filter or PT1 filter to determine the information concerning the reliability of the prediction.

5. The method according to claim 1, wherein the determining of the information includes taking a description of a weighting into account to determine the information concerning the reliability of the prediction.

6. The method according to claim 5, wherein the weighting takes into account at least one item of information about the system noise and/or at least one model error.

7. The method according to claim 1, further comprising:
determining a Kalman gain using a low-pass filtered measurement vector.

8. A computer program comprising instructions configured to, when the computer program is executed by a computer, prompt said computer to carry out the method according to claim 1.

9. A non-transitory machine-readable storage medium comprising the computer program according to claim 8.

10. A system for determining a position of a mobile object, comprising:
a controller configured to estimate at least one system state with a Kalman filter in which measured values measured by at least one sensor of the system are fed to the Kalman filter and the Kalman filter outputs an estimation result and at least one associated item of information concerning a reliability of the estimation result by carrying out a prediction and a correction,
wherein the controller is configured to estimate the at least one system state by:
determining a first description of a first state in a time step taking into account a second description of a second state from a previous time step;
determining a filtered description of the first state at the time step taking into account the first description of the first state and a filtered description of the second state from the previous time step; and
determining information concerning a reliability of the prediction at the time step taking into account the first description of the first state and the filtered description of the first state.
